(19) United States
(12) Patent Application Publication
(10) Pub. No.: US 2013/0050499 A1
(43) Pub. Date: Feb. 28, 2013

(54) INDIRECT TRACKING

(71) Applicants: Istvan Siklossy, Vienna (AT); Michael Gervautz, Vienna (AT)

(72) Inventors: Istvan Siklossy, Vienna (AT); Michael Gervautz, Vienna (AT)

(73) Assignee: Qualcomm Incorporated, San Diego, CA (US)

(21) Appl. No.: 13/306,608

(22) Filed: Nov. 29, 2011

Related U.S. Application Data
(60) Provisional application No. 61/529,135, filed on Aug. 30, 2011.

(51) Int. Cl. H04N 5/225; G06K 9/00

(52) U.S. Cl. 348/169; 382/103; 348/E05.024

(57) ABSTRACT

A mobile platform in a multi-user system tracks its own position with respect to an object and tracks remote mobile platforms despite being an unknown moving objects. The mobile platform captures images of the object and tracks its position with respect to the object as the position changes over time using the multiple images. The mobile platform receives the position of a remote mobile platform with respect to the object as the second position changes over time. The mobile platform tracks the position of the mobile platform with respect to the remote mobile platform using the position of the mobile platform and the received position of the remote mobile platform. The mobile platform may render virtual content with respect to the object and the remote mobile platform based on the tracked positions or may detect or control interactions or trigger events based on the tracked positions.

### CROSS-REFERENCE TO RELATED APPLICATION(S)

This application claims priority under 35 USC 119 to provisional application No. 61/529,135, filed Aug. 30, 2011, which is assigned to the assignee hereof and which is incorporated herein by reference.

### BACKGROUND

1. Background Field

Embodiments of the subject matter described herein are related generally to position and tracking, and more particularly to tracking the changing position of a remote mobile device.

2. Relevant Background

Tracking is used to estimate a mobile device's position and orientation (pose) relative to an object or to a coordinate system. One use of tracking is in augmented Reality (AR) systems, which render computer generated information that is closely registered to real world objects and places when displayed. When tracking is successful, the AR system can display the computer generated information tightly coupled to the real world objects, whereas without successful tracking the computer generated information would be displayed with little or no connection to the real world objects displayed. Conventionally, successful tracking and augmentation can be done only for known objects, i.e., objects that have been modeled or for which reference images are available, or in static scenes, i.e., scenes in which there are no moving unknown objects. Current systems are not capable of tracking unknown moving objects. Accordingly, an improved system for tracking unknown objects is desired.

### SUMMARY

A mobile platform in a multi-user system tracks its own position with respect to an object and tracks remote mobile platforms despite being an unknown moving objects. The mobile platform captures images of the object and tracks its position with respect to the object as the position changes over time using the multiple images. The mobile platform receives the position of a remote mobile platform with respect to the object as the second position changes over time. The mobile platform tracks the position of the mobile platform with respect to the remote mobile platform using the position of the mobile platform and the received position of the remote mobile platform. The mobile platform may render virtual content with respect to the object and the remote mobile platform based on the tracked positions or may detect or control interactions or trigger events based on the tracked positions.

In one implementation, a method includes capturing multiple images of an object with a first mobile platform; tracking a first position of the first mobile platform with respect to the object using the multiple images as the first position changes over time; receiving a second position of a remote mobile platform with respect to the object as the second position changes over time; and tracking a third position of the first mobile platform with respect to the remote mobile platform using the first position and the second position as the third position changes over time.

In another implementation, an apparatus includes a camera adapted to image an object; a transceiver adapted to receive a first position of a remote mobile platform with respect to the object as the first position changes over time; and a processor coupled to the camera and the transceiver, the processor being adapted to track a second position of the camera with respect to the object using images captured by the camera as the second position changes over time, and track a third position of the camera with respect to the remote mobile platform using the first position and the second position as the third position changes over time.

In another implementation, an apparatus includes means for capturing multiple images of an object with a first mobile platform; means for tracking a first position of the first mobile platform with respect to the object using the multiple images as the first position changes over time; means for receiving a second position of a remote mobile platform with respect to the object as the second position changes over time; and means for tracking a third position of the first mobile platform with respect to the remote mobile platform using the first position and the second position as the third position changes over time.

In yet another implementation, a non-transitory computer-readable medium including program code stored thereon, includes program code to track a first position of a first mobile platform with respect to an object as the first position changes over time using multiple captured images of the object; program code to receive a second position of a remote mobile platform with respect to the object as the second position changes over time; and program code to track a third position of the first mobile platform with respect to the remote mobile platform using the first position and the second position as the third position changes over time.

### BRIEF DESCRIPTION OF THE DRAWING

FIG. 1 illustrates a multi-user system that includes mobile platforms having the capability of tracking unknown moving objects, e.g., when those objects are other mobile platforms.

FIG. 2 is a flow chart describing the process of indirectly tracking the pose of other mobile platforms in a multi-user system.

FIG. 3 is a block diagram of a mobile platform capable of indirectly tracking the pose of remote mobile platforms.

### DETAILED DESCRIPTION

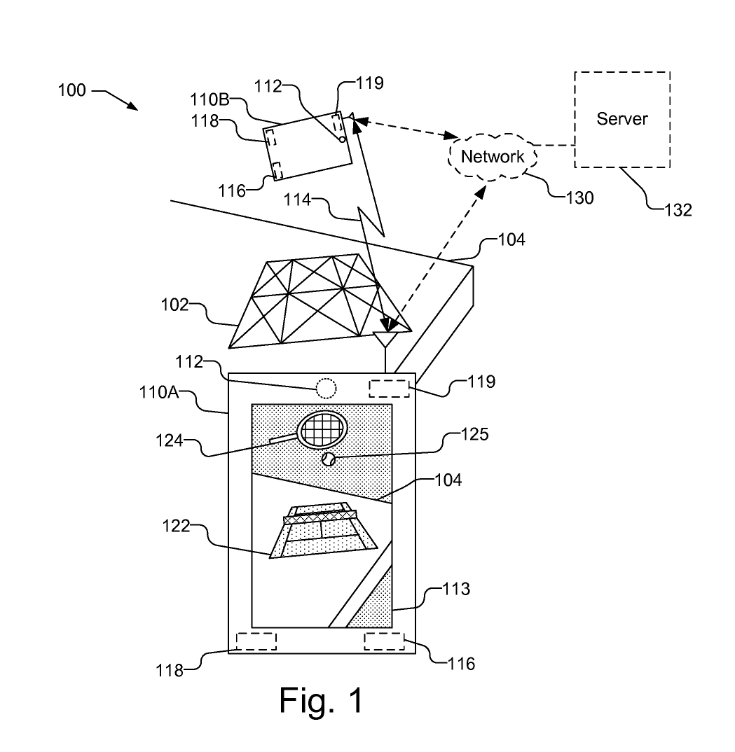

FIG. 1 illustrates a multi-user system 100 with mobile platforms that are capable of tracking unknown moving objects, e.g., when those objects are other mobile platforms. The multi-user system 100 is illustrated as including a first mobile platform 110A and an additional mobile platform 110B, sometimes collectively referred to as mobile platforms 110. While only two mobile platforms 110 are illustrated in FIG. 1, additional mobile platforms may be included in the multi-user system 100 if desired. It should be understood that the mobile platform may be any portable electronic device such as a cellular or other wireless communication device, personal communication system (PCS) device, personal navigation device (PND), Personal Information Manager (PIM), Personal Digital Assistant (PDA), laptop, camera, or other suitable mobile device that is capable of visual tracking and receiving communication signals. As illustrated in FIG. 1, the multi-user system 100 is used for an augmented reality (AR) type application, but it should be understood that the multi-user system 100 is not limited to AR applications and may be used with any desired application in which the position and orientation (pose) of multiple mobile platforms 110 is tracked.

Each mobile platform 110 includes a camera 112 for imaging the environment and a display 113 on the front side of the mobile platform 110 (not shown on mobile platform 110B) for displaying the real world environment as well as any rendered virtual content. The real world environment in FIG. 1 is illustrated as including an object in the form of a game board 102 on a table 104. Mobile platform 110A includes a tracking system 116 that tracks the pose of the mobile platform 110A with respect to the game board 102, e.g., using the game board 102 as a reference target. In other words, the game board 102 is a known object that the tracking system detects in each image captured by the camera 112 and tracks by comparing the current image to a reference image of the game board 102 to determine the pose of the camera 112, and thus, the mobile platform 110 with respect to the game board 102. Tracking reference objects is well known in the art. Alternatively, the tracking system 116 may be a reference free system that tracks the pose of the mobile platform 110A with respect to the environment. Reference free tracking does not require prior knowledge of an object, marker or natural feature target, but can acquire a tracking reference from the environment in real time, such as performed by simultaneous localization and mapping (SLAM) or planar (SLAM) or other similar techniques, which are also well known in the art. A reference free tracking system 116 generally detects and uses a stationary planar object in real time as the reference for tracking For example, the illustrated game board 102 could be used by a reference free tracking system, and thus, for the sake of simplicity, whether tracking is based on a known reference or reference free, the game board 102 will be assumed to be the referenced object. The other mobile platform 110B includes a similar AR system to track the pose of mobile platform 110B with respect to the game board 102. In the case of reference free tracking, the acquired reference needs to be shared across both mobile devices. For example, the acquired reference may be a planar surface or SLAM map that has been acquired by one device and is shared with the other device.

Thus, each mobile platform 110A and 110B independently tracks its own respective position with respect to the game board 102. As illustrated in FIG. 1, the mobile platforms 110 also include an AR system 118 that renders virtual content positioned one or with respect to the game board 102 on the display 113 using the tracked pose. For example, in FIG. 1 mobile platform 110A is illustrated as rendering a tennis court 122 with respect to the game board 102 on the table 104 in the display 113. When mobile platforms 110A and 110B are using the same application, both mobile platforms 110 may display the same virtual objects with respect to the game board, but from their respective perspective. In other words, mobile platform 110B would also display the tennis court 122 but from the perspective of mobile platform 110B.

Conventional systems, however, are not capable of tracking unknown moving objects. Thus, a conventional system is not able to track another mobile platform and, accordingly, virtual content is not conventionally rendered with respect to other mobile platforms.

The mobile platforms 110 in multi-user AR system 100, however, are capable of tracking other mobile platforms by communicating their respective positions to each other, e.g., in a peer-to-peer network using transceivers 119. For example, the mobile platforms 110 may communicate through directly with each other, as illustrated arrow 114 or through a network 130, which may be coupled to a server (router) 133, illustrated with dotted lines in FIG. 1. The communication between mobile platforms 110 may be one or more of several known communication technologies, including low power wireless technologies, such as infrared (generally known as IRDA, Infrared Data Association), Zigbee, Ultra Wide Band (UWB), Bluetooth®, Wi-Fi®, and wired technologies, such as, universal serial bus (USB) connections, FireWire, computer buses, or other serial connections. The wireless network may comprise a wireless wide area network (WWAN), a wireless local area network (WLAN), a wireless personal area network (WPAN), a cellular network, and so on. A wireless transceiver in the mobile platforms 110 (or an additional wireless transceiver) may be capable of communicating with the wireless network using cellular towers or via satellite vehicles. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN. Those of skill in the art will appreciate that other types of networks may be utilized, and that a wireless transceiver in mobile platforms 110 may be configured to communicate over any number of different networks.

Thus, each mobile platform 110 visually tracks its own pose with tracking system 116 and receives via transceiver 119 the pose of the other mobile platform 110 with respect to the same object, e.g., the game board 102 in FIG. 1. Each mobile platform 110 may then determine and track its pose with respect to the other mobile platform using its own pose with respect to the object and the received pose of the remote mobile platform with respect to the same object. The tracked pose of the remote mobile platform may be used for various applications, including interactions between the two mobile platforms 110, triggering events, selecting a remote mobile platform on the display, e.g., to send a message/file/etc, and rendering virtual content with respect to the other devices as illustrated in FIG. 1. For example, in FIG. 1 virtual content is illustrated as rendered with respect to the other mobile platform 110B as a tennis racket 124 that is rendered over the image of the mobile platform 110B. Additionally, by tracking the pose of the other mobile platform 110B, the interaction of mobile platform 110B with rendered objects, such as the ball 125, can be determined by mobile platform 110A. In a multi user game scenario, the ball simulation may be run on one of the devices, e.g., on mobile platform 110A and the location of the ball 125 in the shared coordinate system is provided to the other participants, e.g., mobile platform 110B. Of course, any desired virtual content may be rendered with respect to the other mobile platform 110B and environment. Moreover, any desired application may use the tracked pose between the two mobile platforms 110.

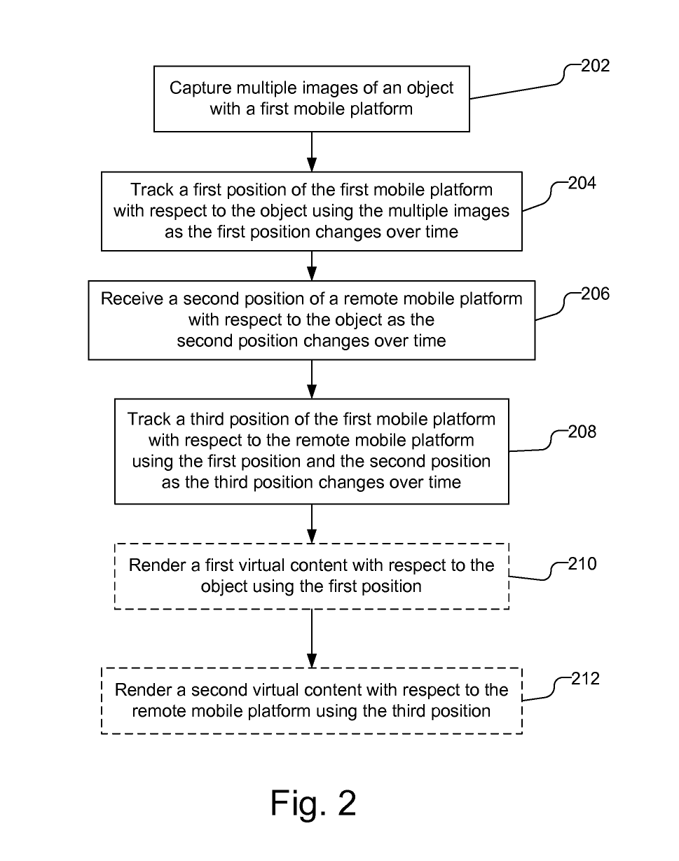

FIG. 2 is a flow chart describing the process of indirectly tracking the pose of other mobile platforms in a multi-user system. As illustrated, multiple images of an object are captured with a first mobile platform (202). The captured images may, but does not necessarily, include both the object and a remote mobile platform. Captured images may be, e.g., frames from video or individual still images. A first position of the first mobile platform with respect to the object is tracked using the multiple images (204) as the first position changes over time. Any desired tracking technique may be used. For example, a reference based or reference free visual tracking system may be used. The tracking system may be composed of both visual and inertial sensors. The visual sensors may include conventional cameras as well as camera systems that are able to deliver depth information (stereo camera, active illumination etc). The tracking technique employed may use a shared reference frame. Thus, where relative sensors, such as accelerometers and gyros are used, a global reference frame to these sensors may be added, e.g., with a camera, high precision GPS, compass or anything else that can deliver a shared reference. A second position of a remote mobile platform with respect to the object is received (206) as the second position changes over time. For example, the second position may be received wired or wirelessly and may be received directly from the remote mobile platform or indirectly, e.g., through network 130 shown in FIG. 1. The data received from the remote mobile platform, thus, may include information such an identifier of the remote mobile platform, identification of the object being tracked by the remote mobile platform, which may be useful to ensure that both mobile platforms are tracking the same object, and six degree of freedom position and orientation of the mobile platform with respect to the object. The mobile platforms may agree on a tracking reference, e.g., by predefining a reference known to both mobile platforms beforehand, or by agreeing on the reference during initialization. Additionally, the position of the first mobile platform with respect to the object may be transmitted to the remote mobile platform. A third position of the first mobile platform is tracked with respect to the remote mobile platform using the first position and the second position as the third position changes over time (208). In addition to the position, the orientation of the mobile platform and the remote mobile platform may be tracked as well.

The tracked position of the mobile platform with respect to the remote mobile platform may be used for various desired applications. For example, as illustrated with dotted lines in FIG. 2, an optional application is rendering virtual content, in which a first virtual content is rendered with respect to the object using the tracked first position (210) and a second virtual content is rendered with respect to the remote mobile platform using the tracked third position (212). The tracked third position, i.e., the position of the mobile platform with respect to the remote mobile platform, may be used for other applications, such as detecting or controlling interactions between the two mobile platforms as well as triggering events. Illustrative, but not limiting, examples including evaluating if a virtual object has interacted with the other mobile platform (e.g., evaluating whether a virtual tennis ball has been hit by the other player's racket); triggering an event if the mobile platform 110A is too far away from mobile platform 110B; selection of an indirectly tracked mobile platform (which may be one of many) by pointing the mobile platform at the desired mobile platform or using the display to indicate the desired mobile platform (e.g., by tapping the screen). For example, selecting an indirectly tracked mobile platform may be used, e.g., to select a co-player in a game or selecting a recipient or sender of a file.

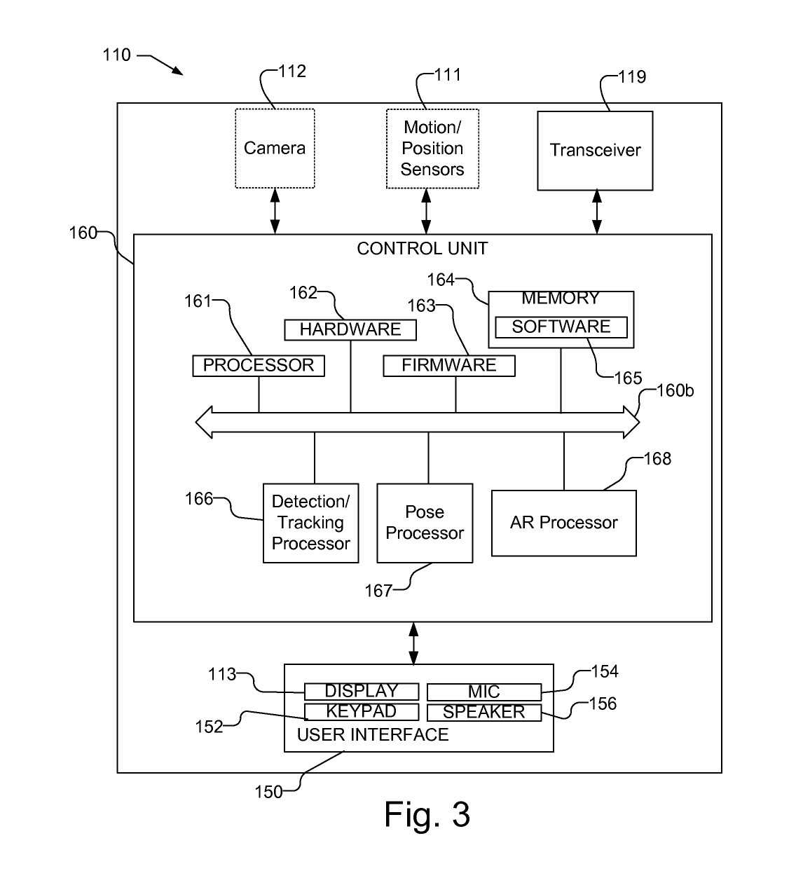

FIG. 3 is a block diagram of a mobile platform 110 capable of indirectly tracking the pose of remote mobile platforms as discussed above. The mobile platform 110 includes a camera 112 for capturing an image of the environment, including an object and another remote mobile platform. The mobile platform 110 also includes a transceiver 119, which may include a receiver and transmitter, for receiving the position and orientation of the remote mobile platform. The mobile platform may optionally include motion/position sensors 111, such as accelerometers, gyroscopes, electronic compass, or other similar motion sensing elements, which may be used to assist in the tracking process as well understood by those skilled in the art. The mobile platform 110 may further includes a user interface 150 that includes the display for displaying the image of the environment, as well as any rendered AR content. The user interface 150 may also include a keypad 152 or other input device through which the user can input information into the mobile platform 110. If desired, the keypad 152 may be obviated by integrating a virtual keypad into the display 113 with a touch sensor. The user interface 150 may also include a microphone 154 and speaker 156, e.g., if the mobile platform 110 is a mobile platform such as a cellular telephone. Of course, mobile platform 110 may include other elements unrelated to the present disclosure.

The mobile platform 110 also includes a control unit 160 that is connected to and communicates with the camera 112 and transceiver 119. The control unit 160 accepts and processes images captured by camera 112 and controls the transceiver 119 to receive the position and orientation of any remote mobile platform and to send the position and orientation to any remote mobile platform. The control unit 160 further controls the user interface 150 including the display 113. The control unit 160 may be provided by a bus 160b, processor 161 and associated memory 164, hardware 162, software 165, and firmware 163. The control unit 160 may include a detection and tracking processor 166 that serves as the tracking system 116 to detect and tracks objects in images captured by the camera 112 to determine the position and orientation of the mobile platform 110 with respect to a tracked object in the captured images. The control unit 160 may further include a pose processor 167 for determining the pose of the mobile platform 110 with respect to a remote mobile platform using the pose of the mobile platform 110 with respect to a tracked object from the detection and tracking processor 166 and the pose of a remote mobile platform with respect to the object as received by the transceiver 119. The control unit may further include an AR processor 168, which may include a graphics engine to render desired AR content with respect to the tracked object using the tracked position and the remote mobile platform using the position of the remote mobile platform received by the transceiver 119. The rendered AR content is displayed on the display 113.

The detection and tracking processor 166, pose processor 167, and AR processor 168 are illustrated separately from processor 161 for clarity, but may be part of the processor 161 or implemented in the processor based on instructions in the software 165 which is run in the processor 161. It will be understood as used herein that the processor 161 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

The methodologies described herein may be implemented by various means depending upon the application. For example, these methodologies may be implemented in hardware 162, firmware 163, software 165, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 164 and executed by the processor 161. Memory may be implemented within or external to the processor 161. If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The mobile platform may include a means for capturing multiple images of an object with a first mobile platform such as the camera 112 or other similar means. The mobile platform may further include a means for tracking a first position of the first mobile platform with respect to the object using the multiple images as the first position changes over time, which may include the camera 112 as well as the detection/tracking processor 166, which may be implemented in hardware, firmware and/or software. The mobile platform may further include a means for receiving a second position of a remote mobile platform with respect to the object as the second position changes over time, which may include the transceiver 119 as well as the processor 161, which may be implemented in hardware, firmware and/or software. The mobile platform may further include means for tracking a third position of the first mobile platform with respect to the remote mobile platform using the first position and the second position as the third position changes over time, which may include the pose processor 167, and which may be implemented in hardware, firmware and/or software. The mobile platform may further include a means for rendering a first virtual content with respect to the object using the first position and means for rendering a second virtual content with respect to the remote mobile platform using the third position, which may include a display 113 and the AR processor 168, which may be implemented in hardware, firmware and/or software. The mobile platform may further include a means for using the first position and the third position to at least one of detect interactions between the mobile platform and the remote mobile platform; control interactions between the mobile platform and the remote mobile platform; and trigger an event in the mobile platform, which may include the processor 161 and may be implemented in hardware, firmware and/or software.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
capturing multiple images of an object with a first mobile platform;
tracking a first position of the first mobile platform with respect to the object using the multiple images as the first position changes over time;
receiving a second position of a remote mobile platform with respect to the object as the second position changes over time; and
tracking a third position of the first mobile platform with respect to the remote mobile platform using the first position and the second position as the third position changes over time.

2. The method of claim 1, wherein the multiple images are of the object and the remote mobile platform, the method further comprising:
rendering a first virtual content with respect to the object using the first position; and
rendering a second virtual content with respect to the remote mobile platform using the third position.

3. The method of claim 1, further comprising using the first position and the third position to at least one of detecting interactions between the first mobile platform and the remote mobile platform; controlling interactions between the first mobile platform and the remote mobile platform; and triggering an event in the first mobile platform.

4. The method of claim 1, further comprising transmitting the first position of the first mobile platform with respect to the object to the remote mobile platform.

5. The method of claim 1, wherein the first position of the remote mobile platform is received directly from the remote mobile platform.

6. The method of claim 1, wherein the first position of the remote mobile platform is received from a device other than the remote mobile platform.

7. The method of claim 1, further comprising tracking a first orientation of the first mobile platform with respect to the object using the multiple images as the first orientation changes over time and receiving a second orientation of the remote mobile platform with respect to the object as the second orientation changes over time, and tracking a third orientation of the first mobile platform with respect to the remote mobile platform using the first orientation and the second orientation as the third orientation changes over time.

8. An apparatus comprising:
a camera adapted to image an object;
a transceiver adapted to receive a first position of a remote mobile platform with respect to the object as the first position changes over time; and
a processor coupled to the camera and the transceiver, the processor being adapted to track a second position of the camera with respect to the object using images captured by the camera as the second position changes over time, and track a third position of the camera with respect to the remote mobile platform using the first position and the second position as the third position changes over time.

9. The apparatus of claim 8, further comprising a display coupled to the processor, wherein the processor is further adapted to render a first virtual content with respect to the object on the display using the second position, and render a second virtual content with respect to the remote mobile platform on the display using the third position.

10. The apparatus of claim 8, wherein the processor is further adapted to use the first position and the third position to at least one of detect interactions between a first mobile platform and the remote mobile platform; control interactions between the first mobile platform and the remote mobile platform; and trigger an event.

11. The apparatus of claim 8, wherein the processor is further adapted to cause the transceiver to transmit the second position of the camera with respect to the object to the remote mobile platform.

12. The apparatus of claim 8, wherein the transceiver is adapted to communicate directly from the remote mobile platform.

13. The apparatus of claim 8, wherein the transceiver is adapted to communicate with the remote mobile platform through a server.

14. The apparatus of claim 8, wherein the transceiver is further adapted to receive a first orientation of the remote mobile platform with respect to the object as the first orientation changes over time, and wherein the processor is further adapted to track a second orientation of the camera with respect to the object using the images captured by the camera as the second orientation changes over time, and track a third orientation of the camera with respect to the remote mobile platform using the first orientation and the second orientation as the third orientation changes over time.

15. An apparatus comprising:
means for capturing multiple images of an object with a first mobile platform;
means for tracking a first position of the first mobile platform with respect to the object using the multiple images as the first position changes over time;
means for receiving a second position of a remote mobile platform with respect to the object as the second position changes over time; and
means for tracking a third position of the first mobile platform with respect to the remote mobile platform using the first position and the second position as the third position changes over time.

16. The apparatus of claim 15, wherein the means for capturing multiple images of the object captures images of the remote mobile platform, the apparatus further comprising:
means for rendering a first virtual content with respect to the object using the first position; and
means for rendering a second virtual content with respect to the remote mobile platform using the third position.

17. The apparatus of claim 15, further comprising means for using the first position and the third position to at least one of detect interactions between the first mobile platform and the remote mobile platform; control interactions between the first mobile platform and the remote mobile platform; and trigger an event in the first mobile platform.

18. The apparatus of claim 15, wherein the means for tracking the first position tracks a first orientation of the first mobile platform with respect to the object as the first orientation changes over time; the means for receiving the second position receives a second orientation of the remote mobile platform with respect to the object as the second orientation changes over time; and the means for tracking the third position tracks a third orientation of the first mobile platform with respect to the remote mobile platform using the first orientation and the second orientation as the third orientation changes over time.

19. A non-transitory computer-readable medium including program code stored thereon, comprising:
program code to track a first position of a first mobile platform with respect to an object as the first position changes over time using multiple captured images of the object;
program code to receive a second position of a remote mobile platform with respect to the object as the second position changes over time; and
program code to track a third position of the first mobile platform with respect to the remote mobile platform using the first position and the second position as the third position changes over time.

20. The non-transitory computer-readable medium of claim 19, further comprising:
program code to render a first virtual content with respect to the object using the first position; and
program code to render a second virtual content with respect to the remote mobile platform using the third position.

21. The non-transitory computer-readable medium of claim 19, further comprising program code to use the first position and the third position to at least one of detect interactions between the first mobile platform and the remote mobile platform; control interactions between the first mobile platform and the remote mobile platform; and trigger an event in the first mobile platform.

22. The non-transitory computer-readable medium of claim 19, further comprising:
program code to track a first orientation of the first mobile platform with respect to the object as the first orientation changes over time;
program code to receive a second orientation of the remote mobile platform with respect to the object as the second orientation changes over time; and
program code to track a third orientation of the first mobile platform with respect to the remote mobile platform using the first orientation and the second orientation as the third orientation changes over time.
